(19) United States
(12) Patent Application Publication
(10) Pub. No.: US 2008/0034390 A1
(43) Pub. Date: Feb. 7, 2008

(54) METHOD FOR NOTIFYING ESG UPDATE IN DIGITAL BROADCASTING RECEPTION TERMINAL

(75) Inventor: Hyung-Jun KIM, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/782,186

(22) Filed: Jul. 24, 2007

(30) Foreign Application Priority Data
Aug. 7, 2006 (KR) 74429/2006

(51) Int. Cl. H04N 7/10

(52) U.S. Cl. 725/40

(57) ABSTRACT

Disclosed is a method and apparatus notifying of the reception of an ESG in digital broadcasting based on a DVB-H scheme. If an ESG corresponding to a category of a digital broadcasting service selected by a user is updated, the terminal provides a function of notifying a user of the update of the ESG.

### PRIORITY

This application claims priority to an application entitled “Method For Notifying ESG Update In Digital Broadcasting Reception Terminal” filed in the Korean Intellectual Property Office on Aug. 7, 2006 and assigned Serial No. 2006-74429, the contents of which are incorporated herein by reference.

### BACKGROUND OF THE INVENTION

1. Field of the Invention

The present invention relates to Digital Video Broadcasting-Handheld (DVB-H), and more particularly to a method for notifying the update or non-update of an Electronic Service Guide (ESG) for performing digital broadcasting.

2. Description of the Related Art

Generally, digital broadcasting transmits broadcasting signals in a digital manner in order to provide users with a service of high picture quality, high sound quality and various levels of Quality of Service (QoS), the broadcasting signals having been transmitted in a conventional analog manner. Such digital broadcasting may include DVB-Terrestrial (DVB-T), Digital Audio Broadcasting (DAB), Digital Multimedia Broadcasting (DMB), MediaFLO, DVB-H, etc.

Of these, the DVB-H corresponds to a technology standard established in order to provide a terminal that is in motion with digital broadcasting at a high reception rate, which can achieve digital mobile multimedia broadcasting capable of providing high picture quality and sound quality broadcasting or contents during driving or moving, regardless of time and place.

Further, the DVB-H scheme transmits an ESG including the most important information necessary for broadcasting services, in a way that is different from other digital broadcasting schemes. Therefore, if the ESG is not normally received or the newest ESG is not received, a digital broadcasting reception terminal equipped with a DVB-H receiver cannot normally perform a digital broadcasting service. The digital broadcasting reception terminal can configure program time information of each channel by using an ESG. Accordingly, the digital broadcasting reception terminal notifies a user whether the ESG has been updated.

However, the digital broadcasting reception terminal does not notify a user whether a specific ESG corresponding to the field of interest of the user from among the updated ESGs has been updated. Further, the digital broadcasting reception terminal does not provide time information of a program corresponding to the field of interest of the user after the update of an ESG.

### SUMMARY OF THE INVENTION

Accordingly, the present invention has been made to solve the above-mentioned problems occurring in conventional systems, and it is an aspect of the present invention to provide a method capable of notifying a user of the update or non-update of an Electronic Service Guide (ESG) corresponding to the field of interest of a user from among updated ESGs.

It is another aspect of the present invention to provide a method capable of displaying time information of a program corresponding to the field of interest of a user at the user's request after update of an ESG.

In accordance with one aspect of the present invention, there is provided a method for notifying an ESG update in a digital broadcasting reception terminal, the method including receiving ESG data and, if ESG data corresponding to a service category set in an ESG update notification function setup step has been updated, notifying a user that the ESG data has been updated.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates the construction of a DVB-H reception terminal according to the present invention;

FIG. 2 is a diagram illustrating the structure of a File Delivery over Unidirectional Transport (FLUTE) session according to the present invention;

FIG. 3 is a diagram illustrating the syntax of a content fragment of ESG data according to the present invention;

FIG. 4 is a flow diagram illustrating an ESG update notification function setup according to the present invention;

FIG. 5 is an exemplary view illustrating the display of a service category during the setup of an ESG update notification function according to the present invention;

FIG. 6 is a flow diagram illustrating the execution of an ESG update notification function; and

FIGS. 7A and 7B are an exemplary views illustrating the notification of an ESG update during the execution of an ESG update notification function according to the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted when it may obscure the subject matter of the present invention.

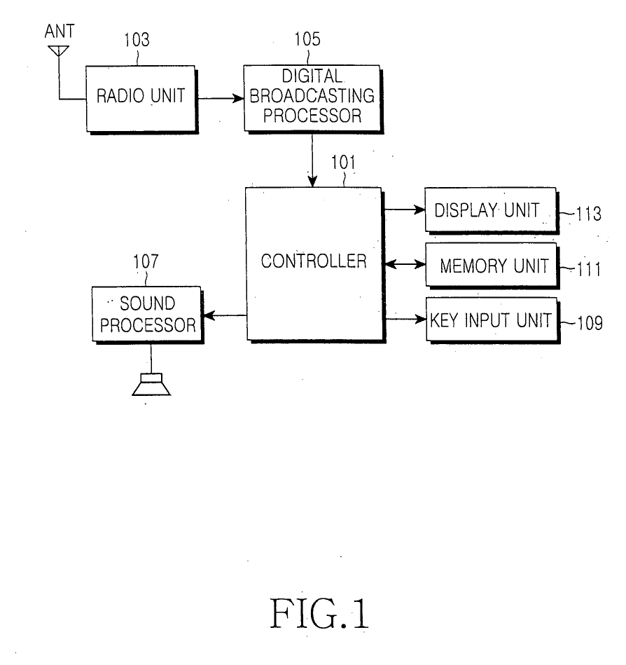

FIG. 1 illustrates the construction of a DVB-H reception terminal according to of the present invention. Hereinafter, the construction of a digital broadcasting reception terminal according to the present invention will be described with reference to FIG. 1.

A radio unit 103 receives Radio Frequency (RF) signals of transport streams of digital broadcasting broadcasted from a digital broadcasting apparatus (not shown). Specifically, in the present invention, the radio unit 103 receives RF signals of both an ESG data stream and a data stream corresponding to a digital service requested by a user. Further, the radio unit 103 includes an RF receiver for low noise-amplifying the received RF signals and down-converts the frequency of the received RF signals, etc.

The digital broadcasting apparatus generates RF signals of transport streams in a DVB-H manner and broadcasts the RF signals. The transport stream includes both an ESG data stream and a digital data stream for providing digital broadcasting.

A digital broadcasting processor 105 receives the RF signals from the radio unit 103, demodulates the RF signals into digital data of baseband signals, and outputs the digital data to a controller 101. Specifically, when the digital broadcasting reception terminal receives DVB-H digital broadcasting according to the embodiment of the present invention, the digital broadcasting processor 105 may become a DVB-H demodulator for obtaining digital broadcasting data by demodulating the RF signals input from the radio unit 103 by an Orthogonal Frequency Division Multiplex (OFDM) scheme.

A sound processor 107 converts sound signals output from the controller 101 into audible sound, and outputs the audible sound. A key input unit 109, which includes both numeral keys (* key, # key, etc.) for input of codes for watching digital broadcasting and function keys for various functions, generates key signals corresponding to a key pressed by a user, and outputs the key signals to the controller 101.

A memory unit 111 stores data necessary for controlling the digital broadcasting reception terminal. Specifically, in the present invention, the memory unit 111 stores ESG data transmitted from the digital broadcasting apparatus.

A display unit 113 displays the current state and operation state of the digital broadcasting reception terminal, and digital broadcasting images under the control of the controller 101, and may be generally constructed as a Liquid Crystal Display (LCD) and an Organic Light Emitting Diode (OLED).

The controller 101 controls each element of the digital broadcasting reception terminal in order to perform a digital broadcasting service. Specifically, in the present invention, if an ESG update notification function setup is requested by a user, the controller 101 receives at least one service category of the field of interest from the user. Further, the controller 101 sets the input category as a service category of an ESG update notification function. Then, the controller 101 performs the ESG update notification function.

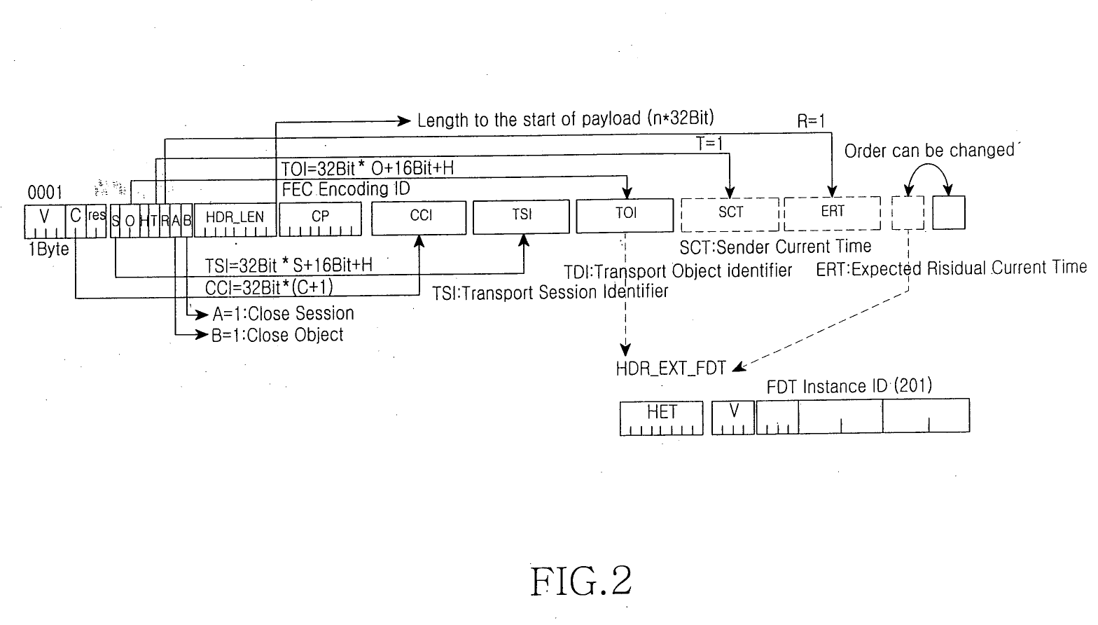

If ESG data is updated, the controller 101 determines if ESG data corresponding to the service category set in the ESG update notification function setup step has been updated. Herein, the controller 101 can determine if the ESG data has been updated through the File Delivery Table (FDT) instance ID 201 from a File Delivery over Unidirectional Transport (FLUTE) session transmitted, as illustrated in FIG. 2. The digital broadcasting apparatus separately transmits an FDT instance ID 201 when sending current ESG data and an FDT instance ID when sending subsequent ESG data. Hence, the controller 101 receives the FDT instance ID 201 from the FLUTE session, and compares the received FDT instance ID 201 with a previously stored FDT instance ID, thereby determining if the ESG data has been updated.

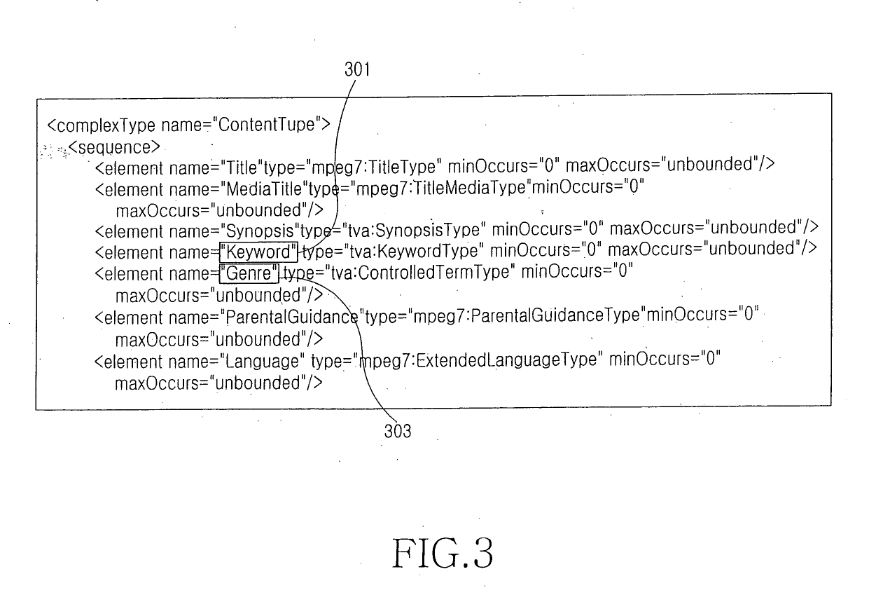

As a result of the comparison, if the received FDT instance ID 201 is different from the previously stored FDT instance ID, the controller 101 receives subsequent ESG data and updates the ESG data. Then, the controller 101 determines if ESG data corresponding to the service category set in the ESG update notification function setup step has been updated from among the updated ESG data. Herein, the controller 101 can determine if the ESG data has been updated by using an ESG content fragment corresponding to each program from among the ESG data. This is described in more detail with reference to FIG. 3. That is, the controller 101 can determine if the ESG data has been updated by using both a sign written in a keyword 301 and a sign written in a genre 303, which are included in the content fragment.

For example, when the service category set in the ESG update notification function setup step is “sports”, the controller 101 searches the ESG content fragment corresponding to each program. Further, the controller 101 determines if a word “sports” has been written in the keyword 301 and the genre 303 of the ESG content fragment. When the word “sports” has been written in the keyword 301 and the genre 303 of the ESG content fragment, the controller 101 can determine that ESG data corresponding to the service category has been updated. If corresponding ESG data has been updated, the controller 101 notifies a user of the update of the corresponding ESG data. When notifying the user of the update of the ESG data, the controller 101 can output a ticker, an icon, a ring tone, etc. Further, if the display of program time information corresponding to a service category from among the updated ESG data is requested by a user, the controller 101 can search for and display the program time information. That is, when searching for the program time information of the ESG data, the controller 101 can search for and display signs written in the “PublishedStartTime” and “PublishedEndTime” of an ESG schedule event fragment corresponding to each program.

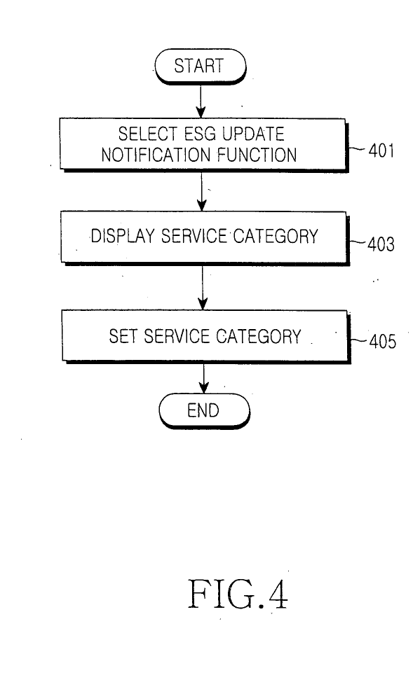

Hereinafter, the category setup and execution of the ESG update notification function will be described with reference to FIGS. 4 to 7.

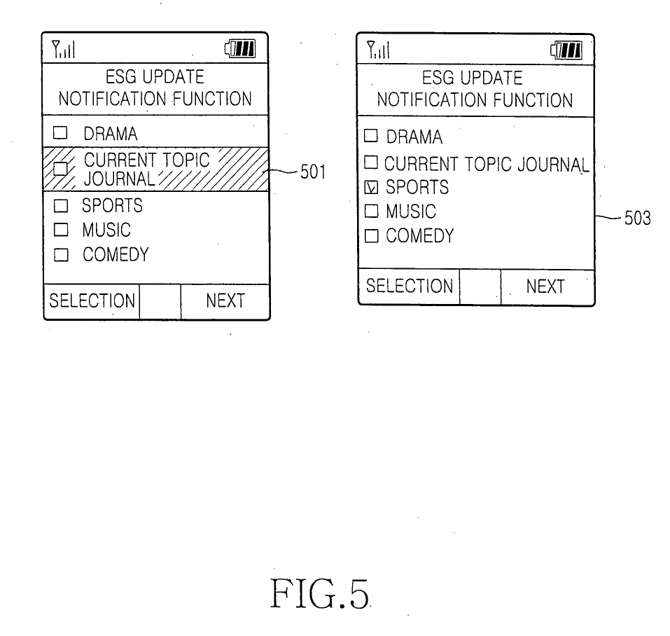

If the ESG update notification function is selected by a user in step 401, step 403 is performed. That is, the controller 101 requests that the user select a service category. Herein, the controller 101 displays a plurality of service categories. If one or more service categories are selected by the user, step 405 is performed. Hereinafter, step 403 will be described with reference to FIG. 5. As illustrated in screen 501 of FIG. 5, the controller 101 can display service categories including music, comedy, sports, current topic journal, drama, etc. If the user selects a certain category from the displayed service categories as illustrated in the screen 503, step 405 is performed.

Returning to FIG. 4, if the user selects at least one service category, the controller 101 sets the selected service category as a service category corresponding to the ESG update notification function in step 405. For example, if a category “Sports” is selected by the user in step 403, the controller 101 sets a service category corresponding to the ESG update notification function as the category “Sports”.

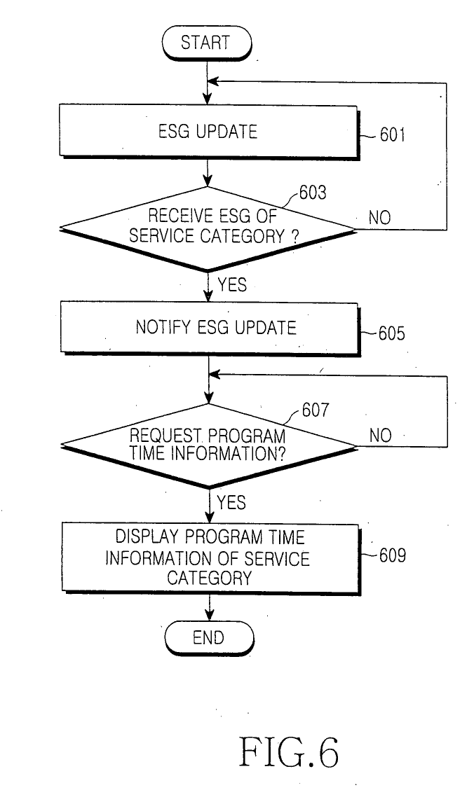

FIG. 6 is a flow diagram illustrating execution of the ESG update notification function after the ESG update notification function setup. Hereinafter, the execution of the ESG update notification function will be described with reference to FIGS. 1 to 7.

If ESG data is updated in step 601, step 603 is performed. The controller 101 receives an FDT instance ID from the FLUTE session, and compares the received FDT instance ID with a previously stored FDT instance ID. If the two FDT instance IDs differ from each other, the controller 101 updates the ESG data. If ESG data corresponding to the service category set in the ESG update notification function setup step is updated, step 605 is performed. However, if ESG data that does not correspond to the service category is updated, step 601 is performed. The controller 101 can determine the update or non-update of the ESG data by using an ESG content fragment corresponding to each program from among received ESG data. For example, when a character, etc., representing a service category has been written in the “Keyword” and the “Genre” of the ESG content fragment, the controller 101 can determine that the ESG data corresponding to the service category has been updated.

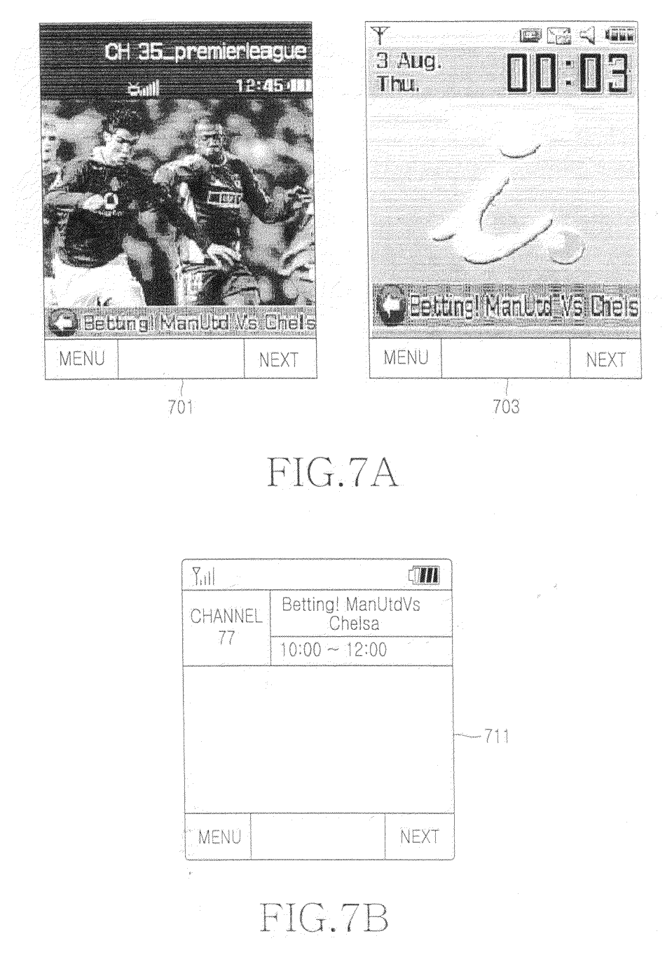

In step 605, the controller 101 notifies a user that the ESG data has been updated. Herein, the controller 101 can notify the user that the ESG data has been updated regardless of the operation state of the digital broadcasting reception terminal. When notifying the user of the update of the ESG data, the controller 101 can use at least one of a ring tone, vibration and a ticker. In the ticker, the update of the ESG data is displayed on the display unit 113 by using characters. For example, when the service category set in the ESG update notification function setup step is a category “Sports”, if ESG data corresponding to the category “Sports” is updated, the controller 101 can display the ticker as illustrated on screens 701 and 703 of FIG. 7. The screen 701 is a screen on which a wireless terminal displays the ticker while outputting digital broadcasting, and the screen 703 is a screen on which the wireless terminal displays the ticker in a waiting mode. Further, the controller 101 can display the title of each program using characters displayed with a ticker type. When displaying the program title with the ticker type, the controller 101 can display characters written in the “Title” of the ESG content fragment.

In the meantime, if the display of program time information of the notified ESG data is requested by a user in step 607, step 609 is performed. Otherwise, step 607 is repeated. In step 609, the controller 101 searches for ESG data corresponding to the service category of the received ESG data. Further, the controller 101 searches for program time information included in the found ESG data and notifies a user of the program time information. For example, while the controller 101 displays the program title corresponding to the service category with the ticker type as illustrated in the screen 701 of FIG. 7, if the program time information is requested by a user, the controller 101 can display program time information including program channel information, broadcasting start time and broadcasting end time, as illustrated in the screen 711 FIG. 7B. When displaying program start time and program end time, the controller 101 can search for and display times written in the “PublishedStartTime” and “PublishedEndTime” of the ESG schedule event fragment, which corresponds to each program, of the received ESG data. Then, the controller 101 can select a certain program from the displayed program time information, and perform broadcasting reservation and record broadcasting.

Through the afore-described steps, the controller 101 performs only the ESG update notification function instead of selecting a digital broadcasting selection menu, thereby notifying a user of the update of ESG data corresponding to the service category desired by the user.

As described above, the present invention provides a method capable of notifying a user of the update or non-update of an ESG corresponding to the field of interest a user from among updated ESGs, and displaying time information of a program corresponding to the field of interest of the user at the user's request after the update of the ESG.

Although a preferred embodiment of the present invention has been described for illustrative purposes, those skilled in the art will appreciate that various modifications, additions and substitutions are possible, without departing from the scope and spirit of the present invention as disclosed in the accompanying claims, including the fill scope of equivalents thereof. For example, in the above embodiment, the update of ESG data is notified to a user by using only a ticker type. However, it is possible to use at least one of a ring tone and vibration in addition to the ticker type.

What is claimed is:

1. A method for notifying a user of an Electronic Service Guide (ESG) update in a digital broadcasting reception terminal, the method comprising the steps of:
receiving ESG data; and
if ESG data corresponding to a service category set in an ESG update notification function setup step has been updated, notifying the user that the ESG data has been updated.

2. The method as claimed in claim 1, wherein the ESG update notification function setup step comprises:
providing the user with a plurality of service categories; and
if at least one service category is selected by the user from the plurality service categories, setting the selected service category as a service category of an ESG update notification function.

3. The method as claimed in claim 2, after notifying of update of the ESG data, further comprising, when notification of program information corresponding to the set service category is requested by the user, searching for the program information from the received ESG data, and providing the program information.

4. The method as claimed in claim 3, wherein occurrence of the update of the ESG data is determined using an ESG content fragment corresponding to each program of the received ESG data.

5. The method as claimed in claim 4, wherein the occurrence of the update of the ESG data is determined by confirming at least one value of a “Keyword” and a “Genre” included in the ESG content fragment.

6. The method as claimed in claim 1, wherein, in the step of notifying of update of the ESG data, at least one of a ticker, a ring tone and vibration is used.

7. The method as claimed in claim 6, wherein the ticker outputs each program title corresponding to the set service category.

8. The method as claimed in claim 3, wherein the program information includes channel information, broadcasting time and title of each program corresponding to the set service category.
